(19) United States
(12) Patent Application Publication
(10) Pub. No.: US 2015/0095406 A1
(43) Pub. Date: Apr. 2, 2015

(54) SYSTEM AND METHOD FOR REMOTE ADMINISTRATION OF AN ELECTRONIC DEVICE

(71) Applicant: GADI DOR, Yehud, IL (US)

(72) Inventor: GADI DOR, Yehud, IL (US)

(21) Appl. No.: 14/043,873

(22) Filed: Oct. 2, 2013

(51) Int. Cl. H04L 29/08

(52) U.S. Cl. CPC H04L 67/10
USPC 709/203

(57) ABSTRACT

The present invention relates to a system and method for remote administration of an electronic device. The system includes a server device to be controlled, a client device for controlling the server device, a client program installed on the client, and a server program which is installed on the server for automatically establishing a secure communication tunnel between the devices so that the controller can be used to effect physical changes on the server. The client and server programs use a unique identifier or key that includes data for locating that specific client, permitting creation of the communication tunnel only with that client device.

### FIELD OF THE INVENTION

The present invention relates to electronic processing devices in general and, in particular, to a system and method for remotely controlling a processing device.

### BACKGROUND OF THE INVENTION

Electronic devices having processors, such as computers, smart televisions, smart phones, and so on, can experience malfunctions or improper usage that require the help of an expert to correct. Getting the expert's assistance often requires a customer to take his device to a help center to receive help in person, or to get instructions from a distance, e.g., over the telephone or by instant messaging. As a further alternative, an expert can perform the required service on the customer's device from a remote location, by using a computer program, typically on the expert's device, to remotely take over control and administer the customer's device.

A large number of programs are known which permit one processing device or computer to administer another. These typically are limited with regard to the types of devices that can be administered thereunder, and/or must be programmed separately in different programming languages in order to permit operation on different platforms. Thus, programs permitting administration of personal computers, for example, typically are unable to provide administration of iPhones®.

Furthermore, to permit remote administration by another computer requires the device owner to perform complex technical tasks or actions, or to provide technical information or details to the expert, e.g., an IP (Internet Protocol) address and/or a random code. Performing these technical tasks assumes some technical knowledge on the part of the device owners, which they frequently do not possess. Therefore, performing these technical tasks can be difficult for the device owner, especially one who is not very familiar with such devices.

There is, therefore, a long-felt need for an easy and convenient way to establish remote control of a processing device, even if one of the parties involved is not a technical expert. Further, it would be desirable if the method could be used cross-platform, on substantially any device having a processor.

### SUMMARY OF THE INVENTION

The present invention relates to methods and devices for exchanging information between processing devices and, in particular, to transferring data or parameters from one device to another for utilization in a computer program in the receiving device. The method includes sending an executable file including a decryption module to the receiving device with an encrypted key as file name, where the key holds data or other parameters to be transferred to the receiving device. The executable file, when run in the receiving device, decrypts the file name, extracts the data from the key, and uses the data when running the executable file.

According to some embodiments, the present invention also provides an easy and convenient cross-platform method and system for coupling a processing device to a remote administrator for remote administration of the device. The system is automatic and self-configuring so that a device owner in need of help must merely download and run a program on his device in order for the remote control to be established. This program, as well as the control program on the controlling device, is programmed once, in a single code base, and then compiled independently for use on each different platform.

The system includes a server device (hereinafter “server”) to be controlled, a remote client device or controller, hereinafter “client”, for administering the server, and a server program for installation on the server for automatically establishing a secure communication tunnel between the devices so that a client program which is installed on the client can be used to effect physical changes on the server. In some embodiments, where both the client and the server are using their actual IP addresses, the communication tunnel is established directly between the server and the client. In other embodiments, where one or both is using a proxy (so that a false IP address is identified) and/or is behind a firewall, a broker server is coupled between the server and the client and the communication tunnel passes through the broker server. A unique identifier or key that is generated by the client program includes connection information of the client. This unique key is used as the name of the file containing the server program sent to the server. This key ensures that the server is coupled only to the particular client the server wishes to administer his device, i.e., the client whose connection information is included in the key.

It will be appreciated that the client and the server can have different operating systems from one another. According to the invention, any device with a processor can administer any other device having a processor. Thus, a computer can administer a cell phone, a smart television, or another computer, for example, and a smart cell phone can administer a personal computer, smart television, or any other device having a processor.

There is provided, according to the present invention, a system for the remote administration of an electronic device having a processor and means for connecting to the Internet or other communication network. The system includes a server device to be controlled, a client device for controlling the server device, a communication tunnel selectively connecting the server device and the client device so that the client can effect physical changes on the server. The system further includes a server program (control program) sent to the server device by the client device, the server program having a file name including information for establishing communication uniquely with the client device over a communication network. The server program is programmed for automatically creating the communication tunnel in response to the server device running the server program.

The present invention further relates to a method for permitting sharing a desktop or screen or administration of a processing device having a large screen by a processing device having a smaller screen, such as a computer with a cellular telephone. The method includes causing the device having a larger screen to display its desktop icons as textual links, and viewing the list of textual links, without icons, on the device having the smaller screen for initiating any one of the textual links.

### BRIEF DESCRIPTION OF THE DRAWINGS

The present invention will be further understood and appreciated from the following detailed description taken in conjunction with the drawings in which:

FIG. 1a is a schematic illustration of a method of preparing information for exchange between two processing devices, according to one embodiment of the invention;

FIG. 1b is a schematic illustration of a method of preparing for receipt of information exchanged between two processing devices, according to one embodiment of the invention;

FIG. 1c is a schematic illustration of a method of preparing information for exchange between two processing devices, according to another embodiment of the invention;

FIG. 1d is a schematic illustration of a method of preparing for receipt of information exchanged between two processing devices, according to another embodiment of the invention;

FIG. 2a is a block diagram of a system for remote control of an electronic processing device, constructed and operative in accordance with one embodiment of the present invention;

FIG. 2b is a block diagram of a system for remote control of an electronic processing device, constructed and operative in accordance with another embodiment of the present invention;

FIG. 3 is a block diagram of a method for remote control of an electronic processing device in accordance with one embodiment of the present invention;

FIG. 4a is a schematic illustration of one method of providing data to an electronic processing device, according to one embodiment of the invention;

FIG. 4b is a schematic illustration of another method of providing data to an electronic processing device, according to another embodiment of the invention;

FIG. 5a is a screen shot illustrating an exemplary desk top display, according to the prior art; and

FIG. 5b is a screen shot illustrating exemplary desk top display, according to one embodiment of the present invention.

### DETAILED DESCRIPTION

The present invention provides a method for transferring data or parameters between electronic devices having processing capabilities (hereinafter “processing devices”), where the data will be used by the receiving device. The electronic processing devices each preferably include means, such as a modem, for connecting to the Internet or other communication network (e.g., a Wi-Fi network, local area network [LAN], Intranet network, etc.). Such devices can include, as non-limiting examples, personal and laptop computers, tablets, smart televisions, smart phones, PDAs (personal digital assistants), and so forth.

The method includes sending an executable file including a decryption module to the receiving device with an encrypted key as the file name, where the key holds data or other parameters to be transferred to the receiving device. The executable file, when run in the receiving device, decrypts the file name, extracts the data from the key, and uses the data when running the executable file. In this way, data selected by the transmitting device can be transferred to and automatically utilized by the receiving device, without the user of the receiving device being required to perform any action other than initiating the received file.

The present invention also relates to a method for providing a cross-platform computer program that can be written once, i.e., a single source code, and that can be implemented on substantially any platform (a group of supported platforms). The main computer program is written in a single cross-platform programming language, such as Free Pascal or HAXE, possibly with an appropriate extension—Lazarus (for Free Pascal), HAXENMe (for Haxe) or OpenSL or the like. The main program incorporates one or more dynamically linked libraries, such as a DLL (Dynamic-Link Library), an NDLL (a Native Dynamic Link Library) or DSO (Dynamic Shared Object), which includes pre-programmed code prepared for a particular platform. The pre-programmed code may be selected from a suitable Library and/or may be programmed in C and/or C⁺⁺ or other native language appropriate for a particular platform or Operating System (OS). At present, Free Pascal with Lazarus is preferred, as it is also multi-platform, meaning that it is compiled on the level of the processor, and it also has a cross-platform and multi-platform user interface (UI). This allows the source code to be programmed once, in a single language, for each of the end users (operating systems) and compiled on one Operating System or platform for a variety of different Operating Systems. It will be appreciated that a further advantage of a multi-platform programming language is that it permits the program to be more flexible, so that it can be adapted to later developed devices and technologies.

The main program and the dynamically linked libraries (DLL or DSO) are then compiled together with one another for a variety of different platforms on which the program is to be run. It will be appreciated that, when using a multi-platform language like Free Pascal, which is also a compiler, it is possible to cross compile, or create binaries (executables) for different platforms than the one used for compilation. Thus, the source code can be compiled with the appropriate libraries for each of the various platforms on a single platform, for example, on Windows 7 to create programs that can run on Linux, Android, etc., as well as on Windows. Alternatively, a cross-platform programming language that compiles on the level of the Operating System, such as HAXE, can be used. However, in this case, it is not possible to cross compile, so the program and the libraries must be compiled with one another independently on each platform (i.e., on Windows, on Linux, on Ios) for that specific platform.

The present invention will be described herein with reference to a system for establishing and maintaining remote administration between processing devices, for which it is particularly suited, although it will be appreciated that the invention is not limited to such a use and this method is suitable for programming any cross platform computer program. The system for remote administration includes a server device to be controlled and a client device for controlling the server device. A computer program sent by the client device, or downloaded from a website, to the server device, hereinafter the “server program”, when accessed and run on the server, as by a mouse click, automatically creates a communication tunnel between the server device and the client device. Over this communication tunnel, the client device, using a computer program called the “client program” herein, administers the server and can effect changes in the server, for example, moving the mouse, opening and displaying files, or modifying files in a memory of the server device.

The automatic creation of the communication tunnel is accomplished by means of a file sent by the client device that contains the server program and has a unique file name that includes encrypted connection information of the client that can be decrypted and used to locate and connect to the client device over the network. This encrypted information preferably includes the IP or other network address of the client or the network address of a broker server, if the client is acting through a broker server. In the latter case, the encrypted information also includes a client identifier which uniquely identifies the client device to the broker server. Alternatively, the client and server can be connected through a secure website, e.g., WSS (Secure WebSocket). In addition, it is possible to create a third party chat over the broker server or the WSS tunnel.

The user of the server signifies his agreement to be administered by the client device by clicking on the received file and thereby initiating the server program. The server program includes a decryption module for decrypting the file name to recover the encrypted connection information, e.g., IP address of the client device. The server program uses this information to automatically contact the client and create a communication tunnel between the server device and the client device over the communication network for transfer of commands and data, etc. Similarly, the server program identifies characteristics of the server device and communicates them to the client to assist in effecting physical changes on the server. At the same time, if a chat server is being used, a chat window opens to permit the client to view an identifier of each server waiting to be administered, and to communicate directly between the client user and the server user, if desired. It will be appreciated that, if there is a firewall or NAT (Network Address Translation) in either device (client or server), the client and server programs will connect through a broker server or a secure intermediate website.

In the exemplary embodiment of the present application, concerning remote administration of processing devices, the source codes of the server program and the client program are written one time, in a single cross-platform and, optionally, multi-platform programming language that can produce applications and source code. This source code can then run on any one of an ever-growing number of target platforms, from the single codebase. A particularly suitable programming language is Free Pascal, a cross-platform and multi-platform, open source programming language. Preferably, Free Pascal is used together with Lazarus, a cross-platform Rapid Application Development (RAD) Integrated Development Environment (IDE) designed to use Free Pascal as its programming language and compilation tool. Free Pascal with Lazarus can also be used to build a user interface for cross-platform implementation. Thus, the programmer creates source code, one time, in such a language, and that source code is then compiled and linked, independently, to produce the executable native code for each of a multiplicity of operating systems. In this way, the single source code can be compiled for use by devices traditionally requiring native language compilers (e.g., C++), as well as those traditionally requiring virtual language compilers (e.g., Java). This permits the program to be implemented on client and server devices running substantially any Operating System (OS), including but not limited to Windows, Linux, Mac, IOS, Android, Media Center, etc., in the network layer.

The source code may incorporate one or more dynamically linked libraries, such as DLLs (Dynamic-Link Library) (.dll) or DSOs (Dynamically linked Shared Object) (.so or .o) libraries, for performing a plurality of desired functions in the final program. Each dynamically linked library is prepared for the particular platform or operating system on which it will run. As described below, these dynamically linked libraries may be created using selected Libraries, to permit the incorporation of pre-programmed source code and obviate the need for programming, again, every function in the program.

When it is desired to administer a particular processing device (server), the platform of that device is determined. The source code, together with the dynamically linked libraries suitable for that platform, e.g., DLLs or DSOs, is compiled for the operating system of that platform, and the compiled program is run by the server processing device.

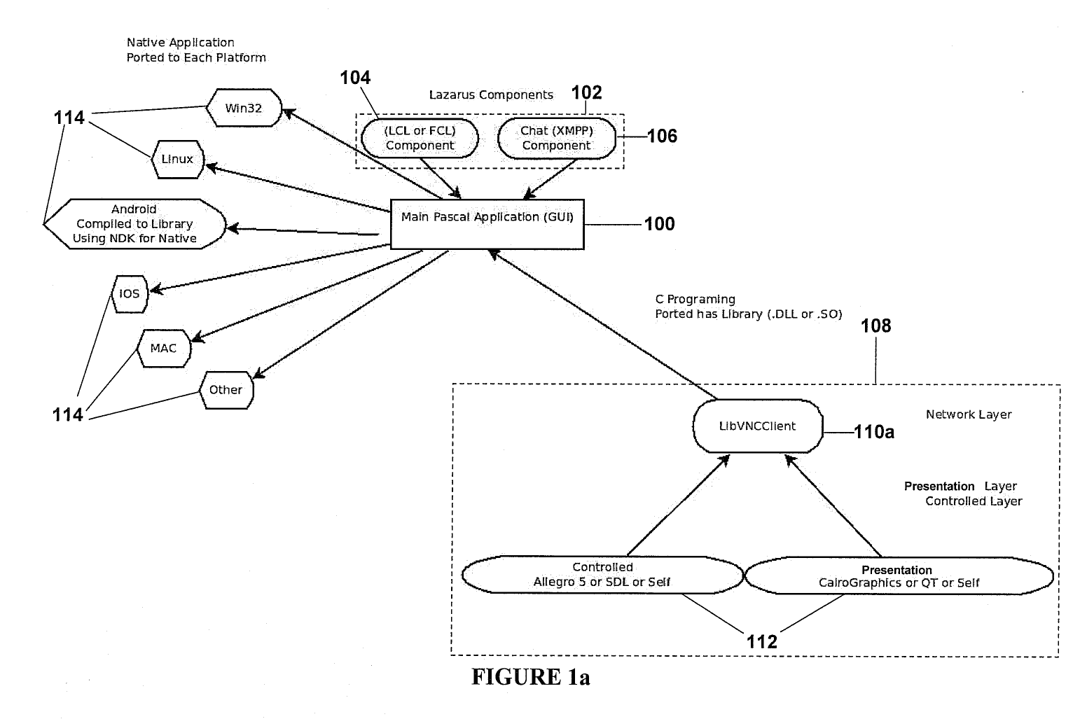

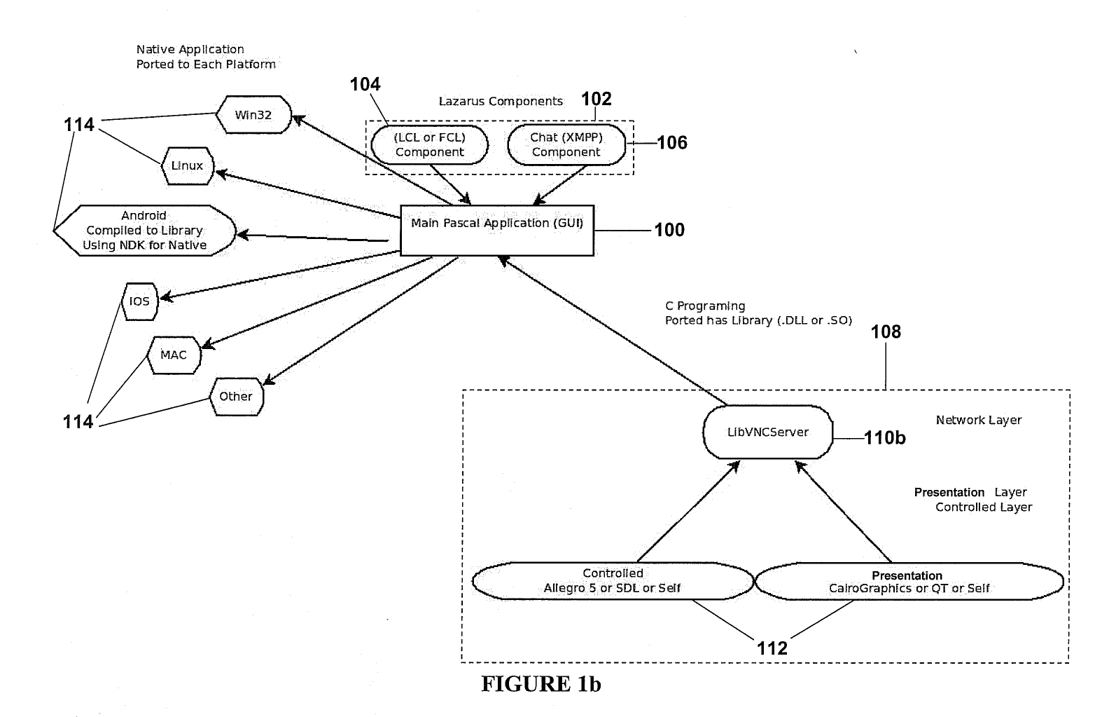

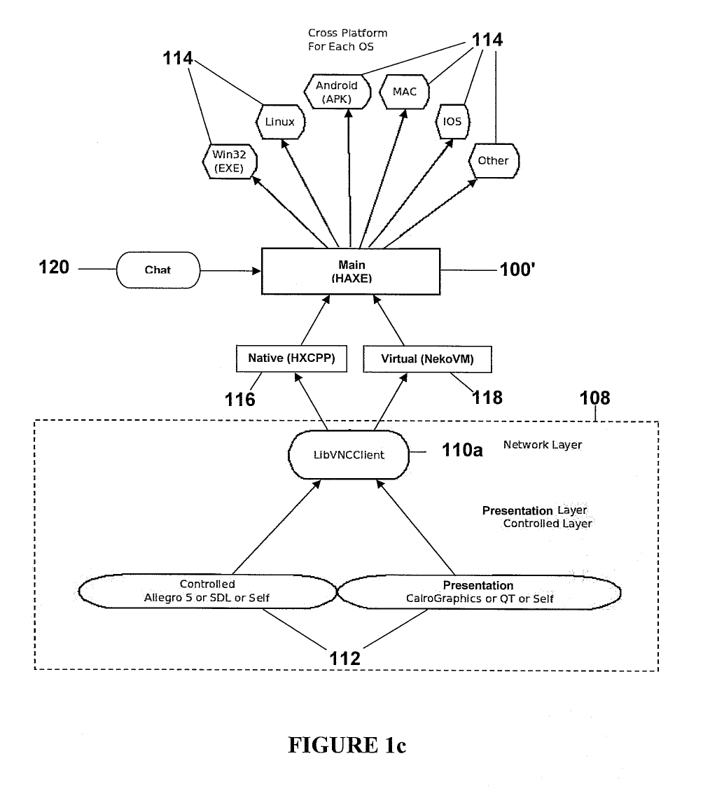

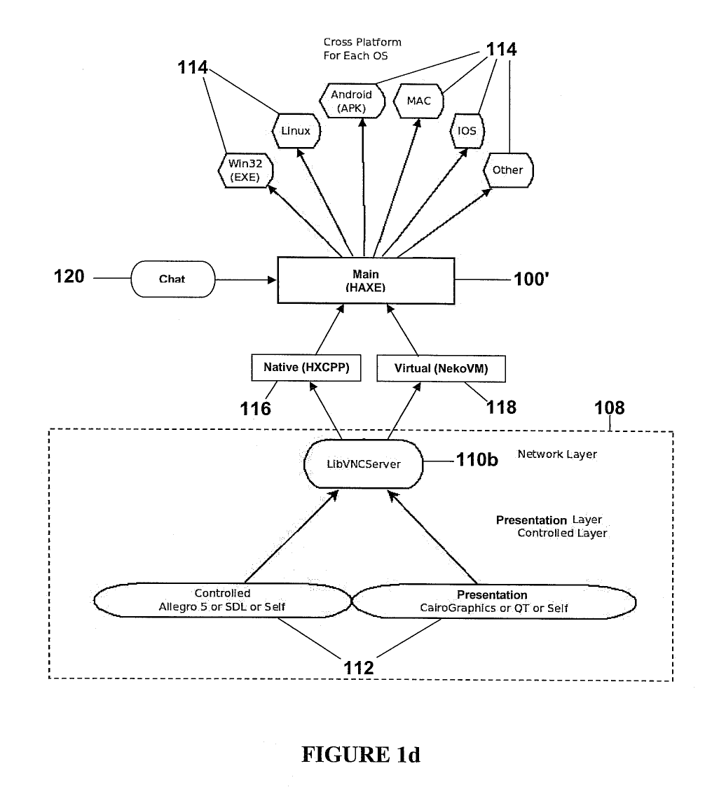

Referring, now, to FIGS. 1a and 1b, there are shown schematic illustrations of a method of preparing cross-platform software, according to one embodiment of the present invention. The illustrated embodiment relates to preparing operating software for a client device and for a server device, respectively, however the invention is not limited to remote administration of processing devices.

According to the exemplary embodiment of the invention shown in FIGS. 1a and 1b, the main source code 100 is written in a cross-platform and multi-platform programming language and compiler, here illustrated as Free Pascal with Lazarus, an integrated development environment (IDE). The multiplatform compiler and linker compiles on the level of the processor. The main Pascal application 100 may utilize certain Lazarus Components 102, such as the Lazarus Component Library (LCL) or the Framework Class Library (FCL), “LCL or FCL” component 104, which are used in building a graphical user interface for the various platforms. A chat component 106 that facilitates connection between the device and a chat server can also be utilized. A non-limiting example of a chat component is an Extensible Messaging and Presence Protocol (XMPP) component that enables connection to a Jabber server.

The main code 100, written in Free Pascal, is able to incorporate a dynamically linked library file, typically a DLL or (D)SO file, 108 for the network layer. File 108 preferably is written and prepared for each operating system. The code for the actual functions required to be performed can be taken from an appropriate Library 110, 112, typically in C or other native language. The library code is incorporated into the dynamically linked library file for compiling together with the source code. After the .dll or .so file 108 has been prepared, it is compiled together with the main source code 100 with the appropriate Graphical User Interface (GUI), resulting in an executable program (the run time code) 114. The run time code is created with a linker for the desired platform. For Android, the code is compiled to a library and an Android linker is used to make it executable. When run on the final platform, the program 114 invokes or calls the file 108, when appropriate, and runs the associated routines or functions. The code can be compiled for a plurality of operating systems, for example, Windows, Linux, Mac, etc. In this way, the code can be written once and then compiled to native code for each operating system. This allows for a plurality of finished programs 114, each one compiled for a different operating system. The server can receive one or more of the finished programs 114 and can send the appropriate one to the client, depending on the device to be controlled. It will be appreciated that, in this manner, an executable program can be created from a single source code for substantially any operating system.

According to the exemplary embodiment of the invention illustrated in the drawings, the actual remote control of the server device is implemented by Virtual Network Computing (VNC) remote control software. In the illustrated embodiments for remote administration, LibVNC Server and LibVNC Client libraries 110 are used. LibVNC Server and LibVNC Client are cross-platform C libraries that allow implementation of VNC server or client functionality. For example, the VNC software transmits the keyboard and mouse events from one device to another, relaying the graphical screen updates back in the other direction, over a network. VNC programming code can be incorporated in the source code by means of an appropriate library. LibVNCClient/LibVNCServer 110a/110b include VNC code suitable for use in the present application (LibVNCServer 110a in the server program and LibVNCClient 110b in the client program). The VNC software routines and functions incorporated into the source code are linked into the program when it is compiled for each different operating system and can be called or invoked from the main program. The VNC code in the dynamically linked library 108 creates the communication tunnel between the client and the server and implements the remote administration of the server, once the server is connected to the client through the communication tunnel. The chat component 106 can be used for administering a chat session, either through the same communication tunnel or through an external chat server.

Preferably, C++ compiler or other cross-platform libraries are used when compiling the code for the presentation layer. Examples of suitable libraries include Allegro 5, SDL and SDL2 for touch screens in Android, IOS, and other embedded systems, and Allegro 5, SDL and SDL2 for mouse/keyboard operation and/or CairoGraphics, GTK or QT for similar functions in Windows, Linux, Mac, etc.

The server program is configured for automatic implementation and is self-configuring. This means that the server program includes code for determination of certain characteristics or settings of the server, such as the presence and type of proxy, or the presence or absence of firewalls. The server program determines the operating system and settings of the server and determines the state of various preselected characteristics. Once it has made this determination, the server program configures itself (i.e., sets its own definitions and settings), so that the customer does not have to enter them manually, as in prior art administration programs.

According to some embodiments of the invention, during self-configuration, the server program automatically determines the language settings, e.g., English, Hebrew, Russian, French, etc., of the operating system on the server. In this case, the client program can also administer a chat session (open a chat window on the client and on the server) in that language and/or provide interface menus or error messages in that language.

Referring, now, to FIGS. 1c and 1d, there are shown schematic illustrations of a method of preparing cross-platform software, according to another embodiment of the present invention. According to this alternative exemplary embodiment, the main source code 100′ is written in a cross-platform programming language which is compiled on the level of, and according to, the OS. One particularly suitable language is HAXE or HAXENME. In this embodiment, HXCPP 116 is preferably used to hold the runtime files required for using a C⁺⁺ backend for HAXE. It contains the headers, libraries and support code required to generate a fully compiled executable program from HAXE code. In this way, the code can be written once and then compiled to native code for each operating system. Alternatively, NekoVM 118 can be utilized, for virtual language compilers. In this embodiment, the program and the libraries are compiled together independently on each platform for that platform. In this case, the main code 100′ also includes code for administering a chat session 120, either through the same communication tunnel or through an external chat server.

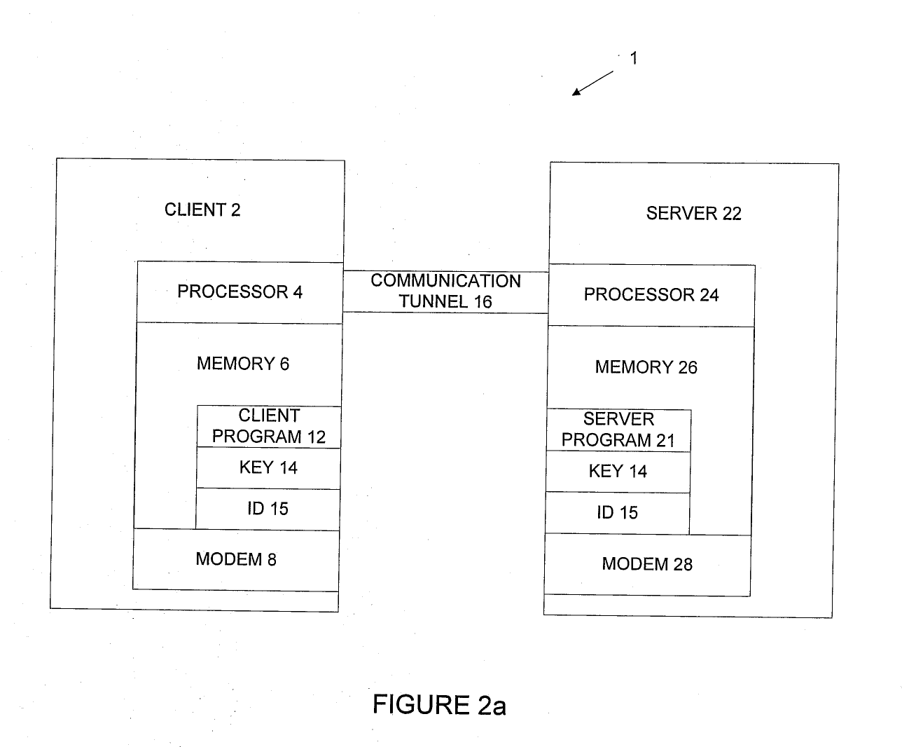

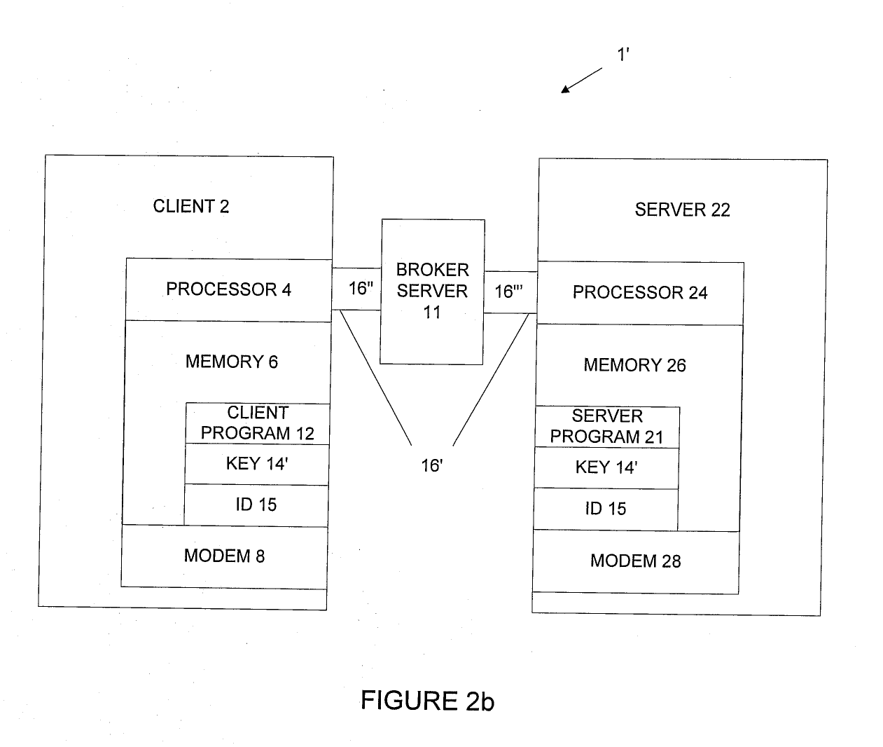

Referring now to FIG. 2a, there is shown a block diagram of a system 1, constructed and operative in accordance with one embodiment of the present invention, for remote administration of an electronic processing device. The system 1 includes a client device 2 including a client processor 4 for processing data, a client memory 6 for storing data, and a client modem 8 for connecting to the Internet, or other communication network. A client program 12 is installed on the client 2 and stored in the client memory 6, for creating the connection between the devices and for later administration of the server. Client program 12 can be executable or web based, and preferably uses base64 lib for encoding and decoding.

A unique identifier of the client is encrypted in a key 14, preferably by the client program 12, which is also stored in the client memory 6. Key 14, described in detail hereinbelow, includes at least one piece of identifying data that is unique to that particular client (e.g., the client's real IP address, a specific client username, or a randomly generated number) and, once decrypted, is used to connect with the client 2 over the Internet. The key 14 is used as the file name for the executable file containing the server program stored in memory 6 to be sent by the client device 2 since the key can change dynamically and it can be added easily to any previously compiled runtime program for any operating system.

It will be appreciated that the client 2 stores a plurality of compiled server programs, each having a file name including an encrypted version of his unique key. The appropriate server program, compiled for the particular device to be administered, is sent by the client to each potential server device. Alternatively, a plurality of compiled server programs with the client's unique key as their file names may be stored on a web site. In this case, the client would direct the server to that web site to download the appropriate server program.

System 1 also includes a server device 22 to be administered by the client device 2. Server 22 includes a server processor 24 for processing data, a server memory 26 for storing data, and a server modem 28 for connecting to the Internet or other communication network. A server program 21 is received from client 2, as described below, stored in the server memory 26 and automatically installed on the server 22 for creating the connection between the devices. The unique identifier key 14 used as the filename for the executable file containing the server control program 21 is stored in the server memory 26. Server program 21 preferably includes a decryption module, e.g., a base64 decoder, for decrypting the key, and libraries that facilitate administration by the remote device. A server ID 15, which can be the server's real IP address, a cell phone number, server username or a random number, or any other identifier, is preferably located or generated by the server program 21 during self-configuration and sent to the client 2. In the illustrated embodiment, the unique ID 15 is transmitted from the server 22 to the client 2 through the secure communication tunnel 16 and, optionally, may be stored in the client memory 6. Alternatively, the ID can be random or temporary. Typically, an ID is used by the server each time it connects with the client. This ID can be different each time or can be the same. The ID is unique for the server at the time of sending to the client and is used by the client to identify a particular server.

A secure communication tunnel 16 created by the server control program 21 selectably connects the client 2 to the server device 22 over the Internet or other communication network. The client administers the server device through this communication tunnel 16.

Preferably, there will be two client's software programs, a client execute program and a web based client. When the server side is not using a broker server and the network connection is direct, as described above, the user uses the client execute software. For example, the client can use VNC (Virtual Network Computing) protocol port 5900 and the server can use VNC protocol port 5500 of the broker server. Since most firewalls block these ports, tunnel software preferably is utilized that connects by port 443 and forward ports 5900/5500 into the broker server. According to yet another embodiment, instead of tunnel software and a broker server, WSS (web socket protocol) can be used, using port 443 directly.

When a broker server is used, the user will use the web based client. FIG. 2b is a diagram of a system 1′, according to this alternative embodiment of the invention. System 1′ is substantially similar to system 1 but it further includes a broker server 11, e.g., a third party server with a real IP address that is connected to the Internet. Broker server 11 is preferably used when the client and/or server is not using a real IP address and/or is behind a firewall. Typically, a broker server will listen to two VNC protocol ports—5900 (client) and 5500 (server). However, most firewalls block these ports. In this case, where the client is using the web based software, both client and server will connect to the broker server by a tunnel on port 443(ssl). Inside the tunnel, they will forward using VNC protocol ports 5500 and 5900 of the broker server. Alternatively, instead of using tunnel software and a broker server, it is possible to utilize WSS (Secure WebSocket protocol), which uses port 443 (ssl) directly.

As can be seen, in this embodiment, the communication tunnel 16′ extending between the client and the server extends via broker server 11. This embodiment is preferred where there is a firewall in the server or NAT (Network Address Translation) (an IETF standard) between the server and the client or in any other case where the client does not encrypt a true IP address in the filename or the server is not using its real IP address. In this embodiment, the secure communication tunnel 16′ is illustrated as being made up of two portions, 16″ and 16″. The client 2 connects to the broker server 11 through a first portion 16″ of secure communication tunnel 16′, and the server 22 connects to the broker server 11 through a second portion 16″′ of secure communication tunnel 16′. In this embodiment, control, exchange of information, chat and file transfer between the server 22 and the client 2 are implemented and performed through broker server 11, under the control or initiation of the client 2.

In this embodiment, when the client 2 is not using his real IP address the key 14′ is encrypted with a unique client identifier with the real IP address of the broker server 11, rather than the client 2. The server 22 contacts the broker server 11 through 16″′ and the broker server 11 recognizes the unique client identifier and knows the clients real IP address. In this way, broker server 11 forwards communications directed to (and from) the client 2 to (and from) that client 2 through 16″. In a case where the client is using its real IP address, but the server 22 is not using its real IP address, the server 22 also contacts the broker server 11 through 16″′, which sends its real IP address to the client 2 through 16″. In this case, the client 2 contacts the broker server 11, and the broker server forwards communications directed to and from the server 22 to and from that server 22. Needless to say, a broker server will also be used when both the client and server are not using their real IP addresses or have firewalls.

It is a particular feature of the invention that the communication tunnel is automatically created between the server and the client without the need for the user of the server to do anything besides downloading and running or initiating a program file containing the server program. Location and connection of the server to, and only to, the intended client is ensured by using a unique identifier or key generated for each client as the name of the file containing the server program. Since each key is unique for a particular client, the server can only be connected to the particular client for which the key was generated. Furthermore, since each server ID is unique, at least at that time, the client can identify the particular server for which that ID was generated and connect thereto at will.

It is a particular feature of the invention that the key, which includes parameters or data that can be utilized by an executable file, is used, after encryption, as the file name of the file containing the executable file. When the executable file is run in the receiving device, the executable file analyzes the file name, decrypts the name to retrieve the key, extracts the data from the key, and uses the data when running the executable file. In order to prevent hacking or man in the middle attack, the key is encoded or encrypted in any appropriate fashion. In order to increase security, in addition to encryption, it is possible to add an additional key that is compiled inside the client and server programs. This key can be used during encryption and decryption, making the software much harder to break or hack.

In the remote administration example, the data in this unique key preferably includes the client device's IP address, either a real address or a proxy IP address, or other data that permits the server to identify and contact the client. The client program encrypts the key and sends it to the server as the filename of the file containing the server program. This key is decrypted in the server by the server program contained in the file, which automatically retrieves the client's IP address or other connection data for connecting the server to that specific client, and establishes the communication tunnel. If the key includes the client's true IP address or address in another communication network, and the server is using its real IP address, then direct communication can be established between the server and the client. If the key does not include the client's actual IP address and/or the server is not using its real IP address, communication will be established through an intermediate proxy server, or broker server, which does have a real IP address. The broker server permits creation of the communication tunnel from the client to the server. In case a client is not using its real IP address, the broker server's real IP address and client identification information will be encrypted in the key.

Once the communication tunnel is created, the server program preferably identifies itself to the client program, so that the client can differentiate between a plurality of servers waiting for remote administration, and select which server to administer at what time. If desired, a temporary or permanent ID is generated by the server program and assigned to the server. This ID is automatically sent back to the client. This ID can include personal information belonging to the server that the server program retrieves during self-configuration, or it can be a random number or ID. This ID will appear on the screen of the client, together with ID's of any other server devices waiting for the client to administer their devices. In this way, the client can select which server to connect to at any given time. Preferably, the client is also provided an indication of the availability of the server (e.g., whether it is on-line or not). When the client chooses to administer control over the server, he simply clicks on the ID of the desired server and the server program and client program (on the two devices) establish remote administration using their respective programs.

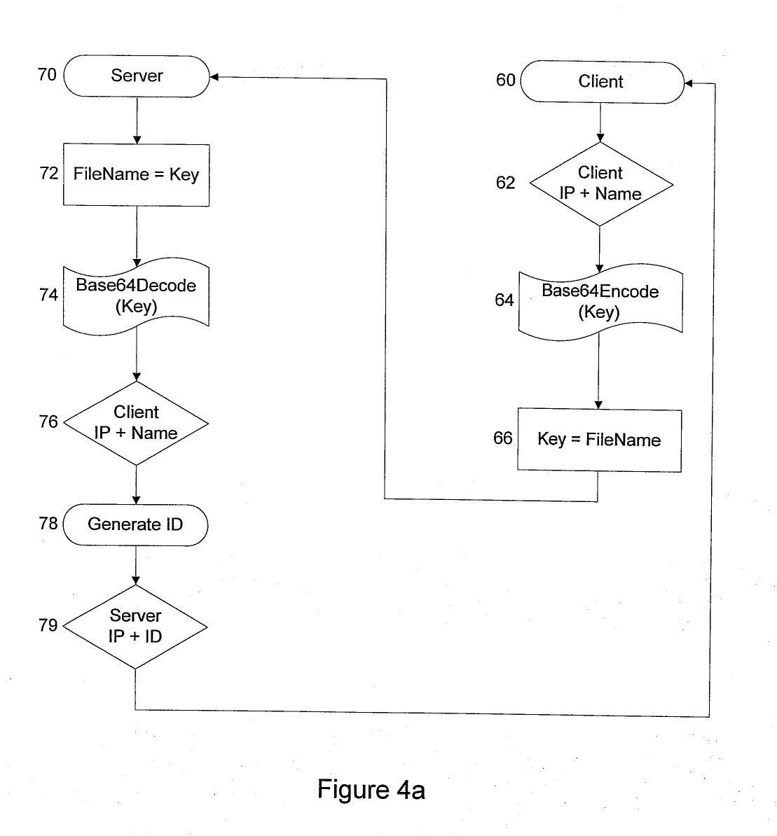

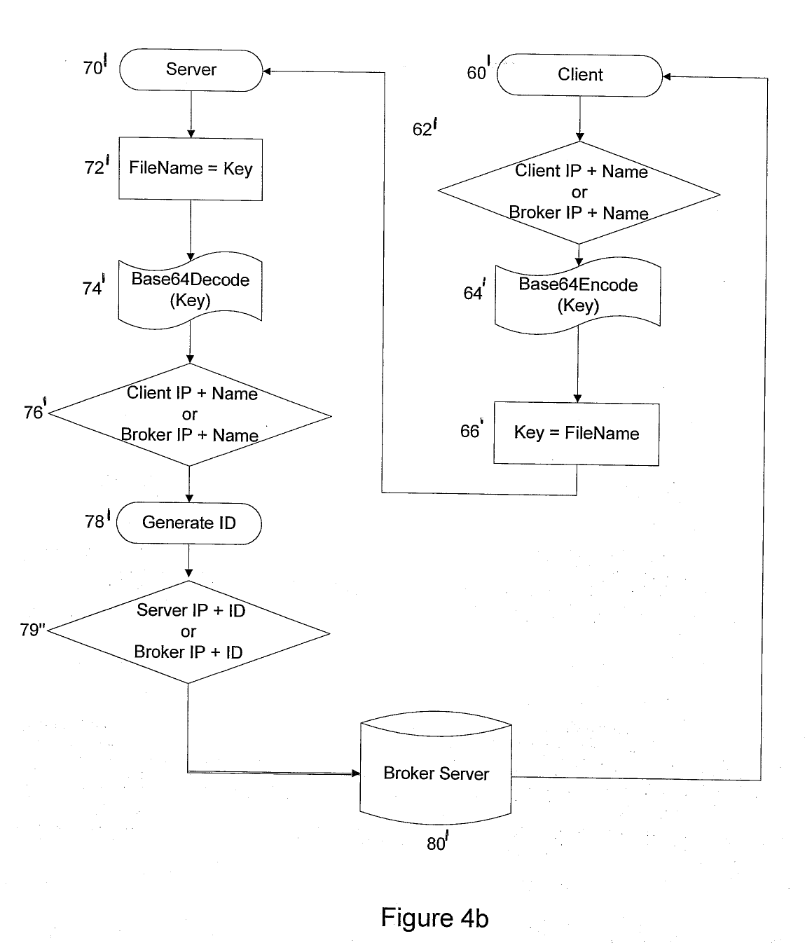

Referring now to FIG. 4a, there is shown a schematic illustration of one method of creating and using a key, according to one embodiment of the invention. First, a sending device selects data or parameters that it wishes to send to the receiving device for utilization in a program for which the key is the file name. In this embodiment, the client provides connection information used to identify and connect to the client to the client program (block 60). Alternatively, the client program can retrieve this information itself from the client device. This identification information, which can be the client device's IP address, as described above, is preferably combined with the client's name (e.g., the name of the expert using the client device, a device username, a random ID number, etc.) (block 62) and a unique key is encrypted (block 64) in any conventional fashion, for example, by base64 encoding. This encrypted key is used as a filename (block 66) on a file sent by the client to the server, preferably on the file containing the server program.

When the server device to be controlled receives and opens the file containing the server program (block 70), the server program in the file analyzes the file name (block 72) and decrypts the key therein, as by base64 decoding (block 74). While decrypting the key, the server control program extracts the contact information (e.g., IP address of the client device, and the client's name) (block 76). Preferably, the server program now retrieves or generates a server ID (block 78) and, if the server is using its real IP address, then the server connects directly to the client using the decrypted connection information (client IP address). By connecting directly, the client knows the server's IP address, which can be used to locate the server so that control can be administered using the client and server programs (block 79).

In FIG. 4b, there is shown a schematic illustration of one method of creating and using a key, according to an alternative embodiment of the invention, where a broker server is used. This method is similar to the one shown in FIG. 4b, but is useful when the client and/or the server is using a proxy or is behind a firewall. Instead of connecting directly to one another, the connection is made through a broker server having a real IP address that knows the identification data of the client and server.

As in FIG. 4a, the client or controller provides connection information, here illustrated as client IP and name, to the client program (block 60′). If the client is using a proxy or is behind a firewall, instead of the client's real IP address, the broker server's IP address will be utilized. The client name is combined with the IP address of the client or the broker server (block 62′) and the key is encrypted (block 64′). This key is used as a filename (block 66′) of a file sent by the client, typically the executable file containing the server program. When the server device to be controlled receives and opens the file containing the server program (block 70′), it analyzes the file name (block 72′) and decrypts the key therein (block 74′). By decrypting the key, the server program extracts the connection information (block 76′). The server program optionally retrieves or generates a server ID (block 78′) and connects to the broker server using the decrypted information. The real IP address of the server (or the broker server is given to the client as well as the server ID via the broker server. If the server is using a proxy or is behind a firewall, instead of the server's real IP address the broker server IP address is taken (block 79′). Contact between the client and the server is forwarded through the broker server (block 80). It will be appreciated that, in lieu of a broker server, the indirect connection between the client and the server can be made through a chat server or through a WSS website.

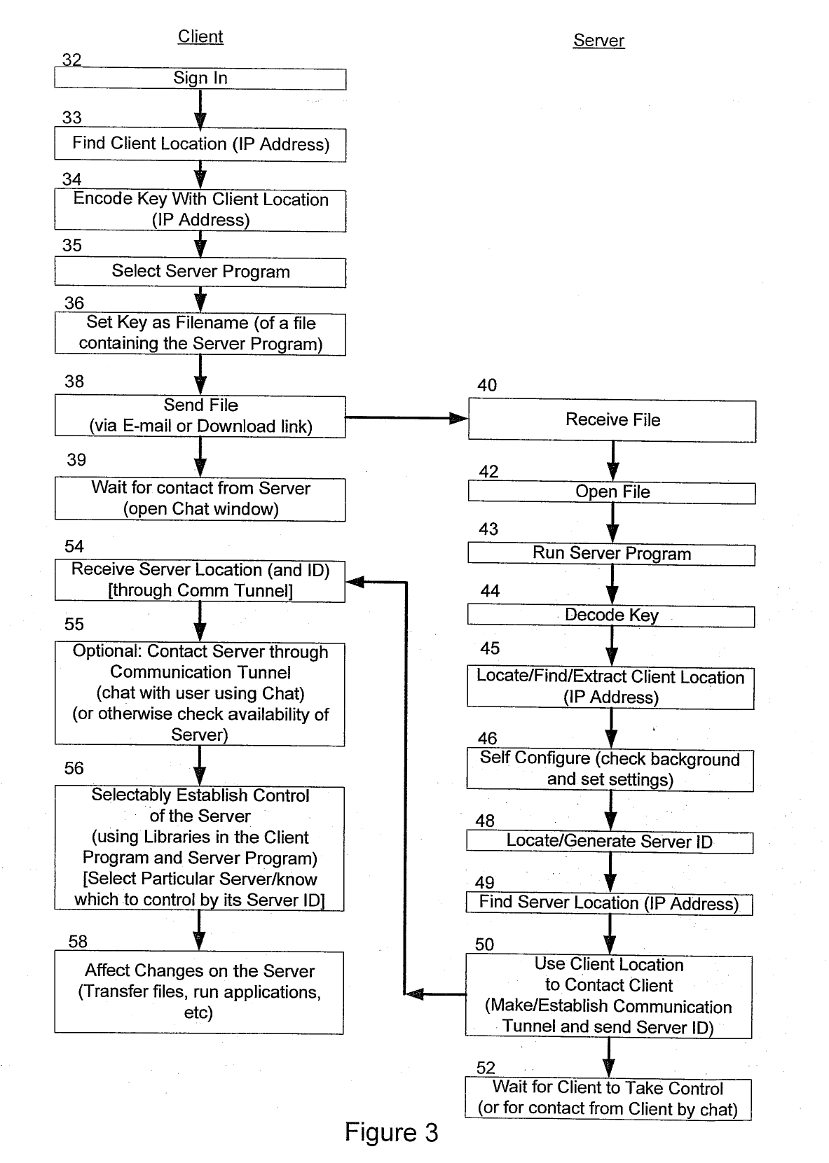

A block diagram of a method for remote control of an electronic processing device, in accordance with one embodiment of the present invention, is as follows, as illustrated in FIG. 3. Preferably, the client and server programs were written using a cross platform source code and were compiled separately for each of a variety of operating systems. These programs are preferably stored in the client database or on a web site on an external server. An expert using a client device optionally signs into the client program, e.g., using a client username and/or password (block 32). The server program takes information for connection to the client (block 33) and uses it to encrypt a unique key (block 34), as described in detail above. Next, the expert selects a server program, from the client database or the external server, according to the operating system of the server device to be administered (block 35). The file containing the server program is given the client's unique file name including the key in encrypted form (block 36). The file is now sent over the communication network, for example, via e-mail, to a customer using the server device to be administered (block 38). Alternatively, a download link can be generated for permitting the user of the server device to download the file containing the server program with the unique file name. This download link can be posted on a website or sent over the communication network (block 38), e.g., via e-mail, to a customer using the server device to be administered. The client program optionally opens a chat window, and waits for contact (identification) from the server device (block 39).

The user of the server receives the file or download link (block 40) and stores the file on the server device. In order to permit the expert to administer the customer's device, the customer merely clicks on the file to initiate it (block 42) and runs the server program (block 43).

From this point, the user of the server device has no more actions to perform. By clicking on the file, the user installs and runs the server program on the server. The server program installs itself on the server. First, the server program analyzes and decrypts the key, which is in the filename of the file downloaded by the download link (block 44). It extracts the connection information contained therein that will be used to connect with the client (e.g., the client's IP address) (block 45). The server program performs self-configuration (block 46) by checking parameters of the server device and setting various settings of its own. The server program optionally retrieves or generates a unique identifier or ID, for example, a phone number, computer name, server username, or server IP address, or a random number, that will be used as the server ID to identify the server by the client device (block 48). The server program checks for a proxy and a firewall in the server and determines whether the connection is to be made from the server to the client directly or via a broker server. The server program then uses the client information extracted from the key to connect to the client and establish a secure communication tunnel through the network between the client and the server (block 50). In cases where there is a firewall or proxy on either side, or the client and/or the server is not using a real IP address, the server connects to the client through a broker server, chat server, or external web site. The server can optionally use this secure communication tunnel to send its unique ID to the client (block 50). After the server identifies itself to the client, it then waits for the client to take control (or contact the client via chat) (block 52).

When the server contacts the client, the client receives the server's location information (either the server's real IP address or the broker server's real IP address). The client can also optionally receive the server ID and can enter it into the client database (block 54). In this case, the client control program uses the ID to identify the server. If the server has a chat window open (while it is waiting), the chat window can indicate the fact that the client has connected with the server. The chat name used for the server is the ID sent to the client. Preferably the chat window includes an indication regarding whether the server is on-line (available for chat and/or remote administration). The client can now optionally administer a chat session with the server (block 55). The client will then selectably establish remote administration over the server through the secure communication tunnel when the expert chooses to do so (block 56). Once the client has remote control over the server device, it is able to administer the server device in any way, including transfer files over the network, or otherwise affect data on the server (block 58) through the secure communication tunnel. In this way, an expert is able to take remote control of a user's device and potentially correct any problems that the device is experiencing.

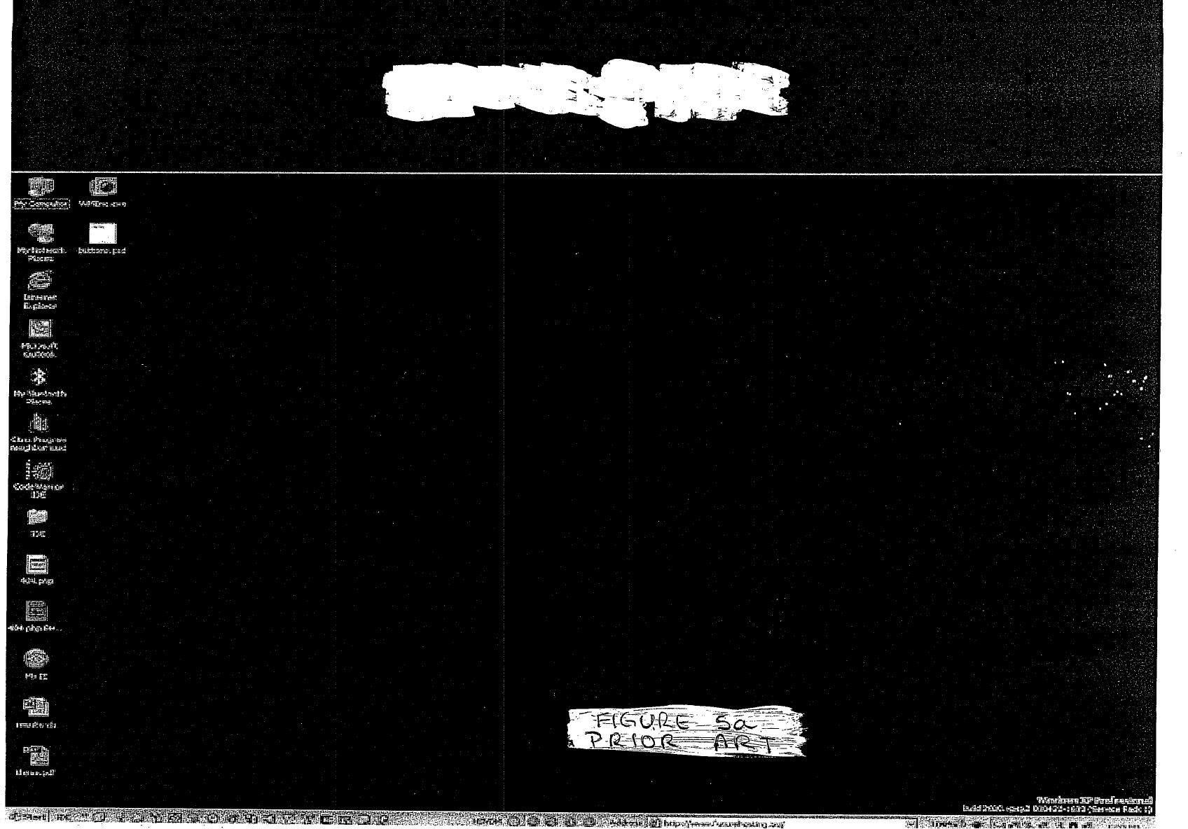

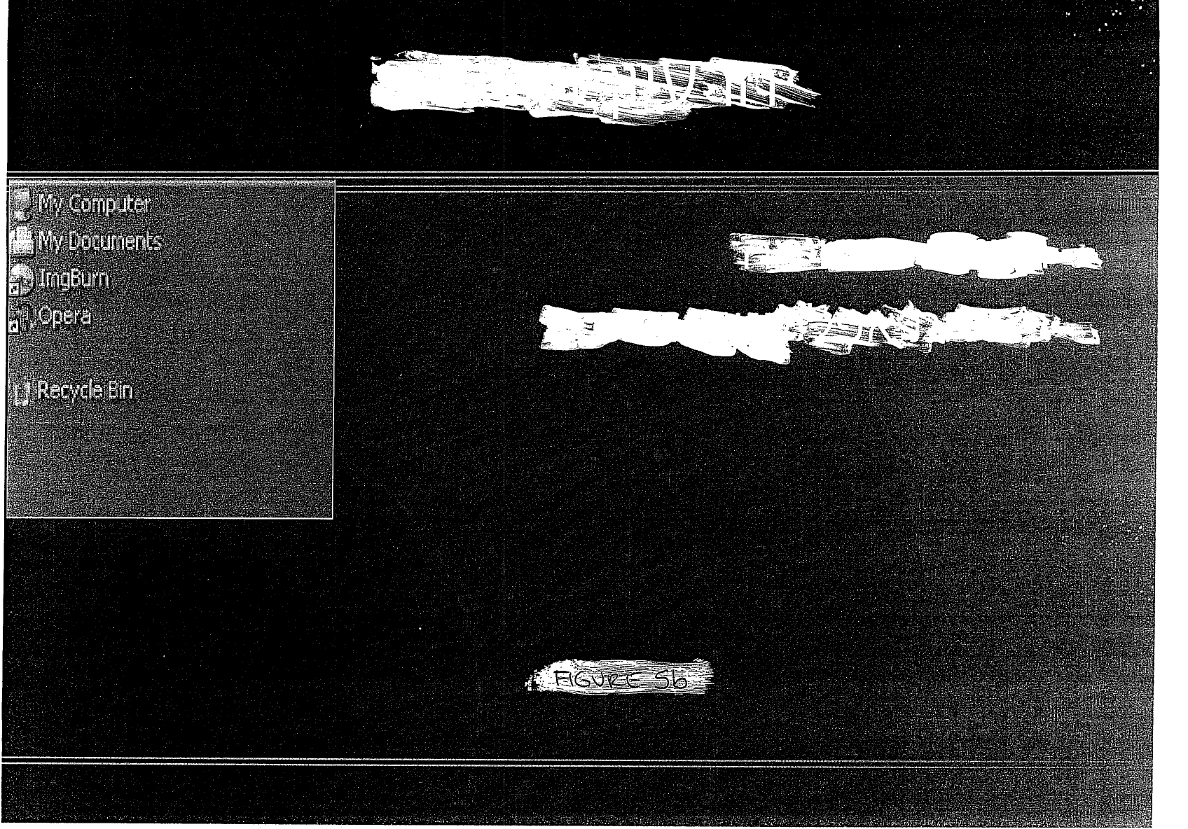

It will be appreciated that when a computer is administering a smart phone, there is no problem viewing and manipulating the entire display of the smart phone on the computer. However, when a smart phone or other relatively small device is administering a computer, television, or other device with a relatively large screen, it can be very difficult to view and manipulate the icons displayed on the computer desktop, as shown, for example, in FIG. 5a, on the small smart phone screen.

Further according to the present invention, when remote administration is established on a server device with a large screen using a client device having a substantially smaller screen, the server programs can convert the desktop into a textual list of links which it sends to the client, as shown in FIG. 5b, instead of icons. The client program tells the server device to convert the icons on the desktop, which are links to various applications, and convert them into a textual list of links for initiating the various applications, for display on the server's desktop and, thus, on the screen of the client device. This is particularly useful when using a smartphone to establish remote administration of a computer. When the expert using the client device clicks on a file name on the list, the application in the server device opens, as if the expert had clicked on the application's icon. The server then sends the graphical information to the client. In this way, the name of the application can be displayed in a textual format on the client, while the application itself can be displayed in a graphical format on the client.

One skilled in the art will recognize that, although the invention has been described as being used for remote control or administration, there are numerous other possible applications for the ideas disclosed herein.

It will be appreciated that the invention is not limited to what has been described hereinabove merely by way of example. Rather, the invention is limited solely by the claims which follow.

1. A system for the remote administration of an electronic device, the system comprising:
a server device to be controlled;
a client device for controlling the server device;
a communication tunnel selectably connecting said server device and said client device so that said client device can effect physical changes on said server device; and
a server program automatically creating the communication tunnel in response to the server device running a control program sent by the client device, the control program having a filename including information for establishing communication uniquely with the client device over a communication network.

2. The system according to claim 1, wherein said communication tunnel is established directly between said server device and said client device.

3. The system according to claim 1, further comprising a broker server, wherein said communication tunnel is established between said server device and said client device through the broker server.

4. The system according to claim 1, wherein said filename includes a key including at least one piece of identifying data is used to uniquely identify the client device.

5. A method for the remote administration of an electronic server device by a client device, the method comprising:
programming a source code in a cross-platform programming language that can produce applications and source code for many different platforms from a single code-base; and
compiling said single source code together with at least one dynamically linked library for a selected one of said group of platforms, to form an executable file, independently, in native code for each selected one of said group of operating systems.

6. The method according to claim 5, wherein said cross-platform programming language is also a multi-platform programming language, compiled at the processor level.

7. The method according to claim 5, further comprising:
adding a unique identifier of a client device as a file name of the executable file to each of said plurality of computer programs; and
sending one of said compiled said unique identifier to said server device by said client device.

8. The method according to claim 5, further comprising:
compiling said single source code to a native language after said step of programming; and wherein
said step of compiling includes compiling said compiled single source code together with at least one native dynamically linked library (NDLL) compiled for a selected one of said group of platforms, to form an executable file, independently, in native code for each selected one of said group of operating systems.

9. The method according to claim 8, further comprising:
adding a unique identifier of a client device as a file name of the executable file to each of said plurality of computer programs; and
sending one of said compiled said unique identifier to said server device by said client device.

10. A method for creating a communication tunnel between a client device and a server device, the method comprising:
encrypting a key by a client device with data for uniquely communicating with the client device;
creating a control program from a source code compiled to a native code of the server device using said key as a file name of the control program;
transmitting said control program by the client device to the server device;
running said control program in said server device, causing the server device to decrypt said key to extract said data for communicating; and
automatically establishing a secure communication tunnel between said server device and said client device over a communications network using said data.

11. A method for remote viewing of an electronic device, the method comprising:
coupling a server device to be controlled having a display to a client device for controlling the server device, the client device having a substantially smaller display than the server device; and
converting icons on the server device to a textual list and sending said textual list to said client device for display as a textual list on a display of said client device.

12. A method for creating a computer program product, the method comprising:
programming a single source code in a programming language that can produce applications and source code for many different platforms from a single code-base;
adding at least one dynamically linked library to said source code, said dynamically linked library being specific to one of several operating systems; and
compiling said single source code with said dynamically linked library to native code, independently for each one of several operating systems.

13. The method according to claim 12:
wherein said step of adding includes adding at least one Native Dynamically Linked Library (NDLL) to said source code, said NDLL being compiled for a selected one of said group of platforms; and
compiling said single source code to native code, independently for each one of several operating systems.

14. The method according to claim 12, wherein said programming language is Free Pascal.

15. The method according to claim 14, wherein programming is accomplished utilizing Lazarus.

16. The method according to claim 12, further comprising storing said compiled source code with a filename that uniquely identifies communication details of a sender of said computer program product.

17. A computer program product comprising computer readable instructions that cause a computer to perform the following steps:
receive a control program from a client device by a server device, said control program programmed from a source code compiled to a native code of the server device using an encrypted a key as a file name of the control program, said encrypted key including data for uniquely communicating with the client device;
run said control program in said server device, causing the server device to decrypt said key to extract said data for communicating; and
automatically establish a secure communication tunnel between said server device and said client device over a communications network using said data.
